(19) United States
(12) Patent Application Publication
(10) Pub. No.: US 2004/0252128 A1
(43) Pub. Date: Dec. 16, 2004

(54) Information visualization methods, information visualization systems, and articles of manufacture

(76) Inventors: Ming C. Hao, Palo Alto, CA (US); Pankaj K. Garg, Sunnyvale, CA (US); Mustazirul Shawn Islam, Roseville, CA (US); Vijay Machiraju, Mountain View, CA (US); Umeshwar Dayal, Palo Alto, CA (US); Sharon Beach, Ojai, CA (US); Klaus Wurster, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/463,716

(22) Filed: Jun. 16, 2003

(51) Int. Cl. G09G 5/00

(52) U.S. Cl. 345/581

(57) ABSTRACT

Information visualization methods, information visualization systems, and articles of manufacture are described. According to one aspect, an information visualization method includes providing data for a plurality of attributes of a plurality of data items, first arranging the data items according to a common attribute having a first scale, first displaying the data items arranged according to the first arranging, selecting a subset of the data items responsive to the displaying, second arranging the data items of the subset according to the attribute having a second scale of increased resolution compared with the first scale, and second displaying the subset of the data items arranged according to the second arranging.

### FIELD OF THE INVENTION

Aspects of the disclosure relate to information visualization methods, information visualization systems, and articles of manufacture.

### BACKGROUND OF THE INVENTION

There are increased desires for improvements in information analysis. For example, with the emergence and increased popularity of the Internet, there is an urgent need for some business analysts to analyze relevant information to improve business operations. The analysis of information may assist with identification of problems with respect to the businesses. In one exemplary instance, information analysis may indicate which Service Level Agreements (SLAs) with contractors are being violated and the respective reasons for the violations. Information analysis may additionally assist with identifying and understanding patterns, for example, the correlations between gold or preferred customers and revenue.

In many cases, data to be analyzed may present a natural hierarchical structure that may be used for partitioning the data into appropriate groupings. Examples include a product category hierarchy for a product type dimension, a time hierarchy (years, days, hours, minutes, seconds) for a time dimension, or a geographical subdivision into regions, states, counties, zip-code areas, etc. Exemplary techniques to visualize categorical datasets include use of bar charts, trees, or maps.

Drawbacks may be experienced by some users with respect to some analysis techniques. For example, visualization schemes that use predefined hierarchical drill-down areas may provide rigid, structured layering which prevent users from discovering unexpected results (i.e., users may not be allowed to select a region of interest across multiple bars or grouping boundaries of a visualization). In addition, the contents of a next hierarchical level show aggregated data (e.g., bar charts) or predefined images (e.g., maps) and data distribution and detailed information may be omitted at individual levels of hierarchy. Sub-layered levels of data in some hierarchical schemes may not include information regarding more than one aspect of the information. Furthermore, it may be inherently difficult to scale the visualization schemes to a large data set.

Aspects of the present invention may provide improved apparatus and methods for visualizing or otherwise presenting data.

### DESCRIPTION OF THE DRAWINGS

FIG. 1 is an illustrative representation of an exemplary information visualization system according to one embodiment.

FIG. 2 is functional block diagram of an exemplary information visualization system according to one embodiment.

FIG. 3 is a first exemplary screen display according to one embodiment.

FIG. 4 is a second exemplary screen display according to one embodiment.

FIG. 5 is a flow diagram illustrating an exemplary construction of graphical representations having different hierarchical levels according to one embodiment.

### DETAILED DESCRIPTION OF THE INVENTION

Aspects described herein provide information visualization systems and methods for dynamically displaying data. A user may dynamically select subsets of data items for further analysis and display in at least one embodiment. As described below, the user may select different attributes of data items to be displayed in different hierarchical levels. Different details of displayed information may be selected at different times corresponding to the data being displayed.

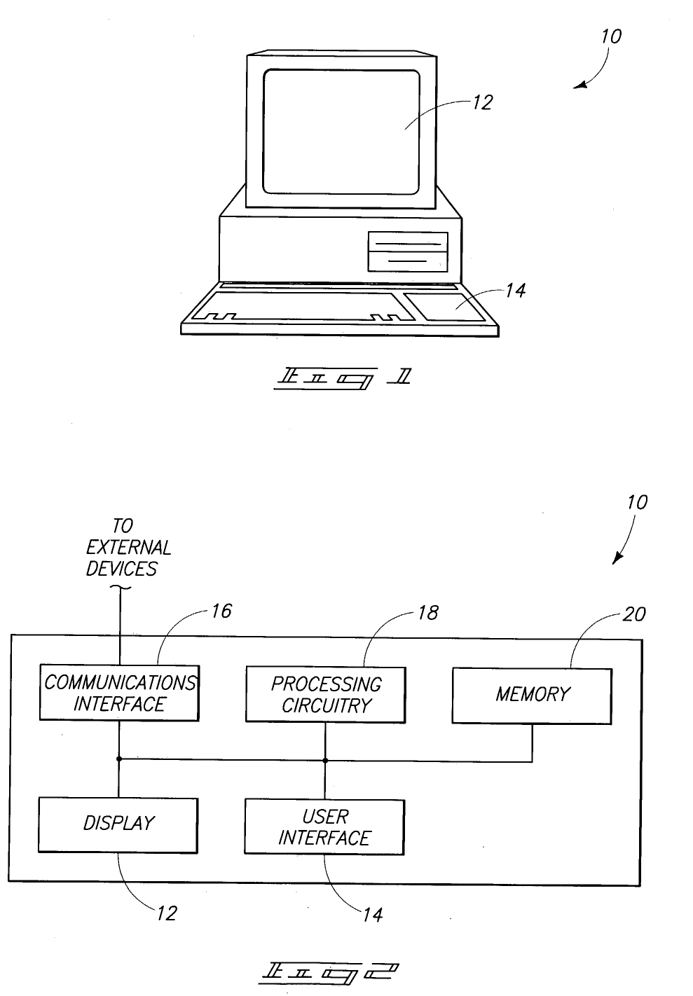

Referring to FIG. 1, an exemplary information visualization system 10 is illustrated. In one embodiment, the information visualization system 10 is configured to visually depict data in a plurality of formats or representations for analysis by a user and which may be selected by a user. The illustrated exemplary information visualization system 10 may include a display 12 and a user interface 14. Information visualization system 10 may be implemented as a computer, personal computer (PC), workstation, or other digital processing configuration capable of visually presenting data.

Display 12 may be configured to visually depict images and may be embodied as a CRT monitor, flat panel display, or other convenient structure for visually representing data. User interface 14 may be configured to receive user inputs and commands. User interface 14 comprises a keyboard in the depicted example configuration. Other configurations of user interface 14 are possible including a keyboard, mouse, voice recognition system, and/or any other device capable of receiving user input.

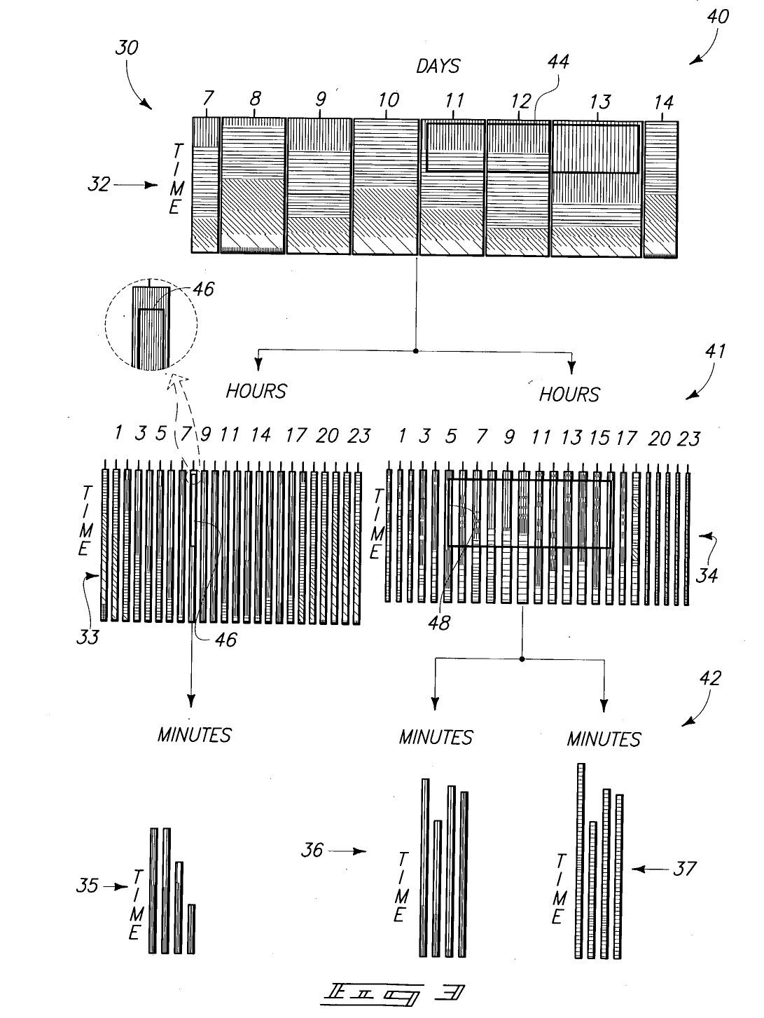

Referring to FIG. 2, additional details of the exemplary information visualization system 10 are shown. The depicted system 10 includes display 12, user interface 14, a communications interface 16, processing circuitry 18, and a memory 20.

Communications interface 16 is configured to implement bi-directional communications with external devices (e.g., receiving a data set from an external device) in one embodiment. Exemplary configurations of communications interface 16 include a modem, USB port, a network interface card (NIC), or any other suitable arrangement to implement external communications.

Processing circuitry 18 implements data processing operations, and control operations of information visualization system 10. For example, processing circuitry 18 may access data and commands, process data and commands, and prepare data for depiction using display 12, a hardcopy or other imaging device (not shown), and/or other purposes. In one embodiment, processing circuitry 18 may comprise a microprocessor or other structure configured to execute programming (e.g., executable instructions) stored within articles of manufacture, such as memory or other appropriate storage device, and embodied as, for example, software and/or firmware instructions. Other embodiments of processing circuitry 18, such as hardware logic (e.g., programmable gate array) or other logic configurations, are possible.

Memory 20 may be configured to store programming such as executable instructions (e.g., software and/or firmware), data, or other digital information and may include processor-usable media. Processor-usable media includes any article of manufacture which can contain, store, or maintain programming or data for use by or in connection with processing circuitry 18 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette such as a floppy diskette, zip disk, hard drive, compact disk, random access memory, read only memory, flash memory, erasable programmable read only memory, or other configurations capable of storing programming, data, or other digital information.

In one embodiment, processing circuitry 18 is arranged to access data and to control the display 12 to depict data for analysis by a user. Processing circuitry 18 may access data from memory 20 or other appropriate source. Data may include a data set comprising a plurality of data items which individually include one or more respective attribute. The data items may have common attributes. Processing circuitry 18 may arrange the data items according to desired parameters as described below in accordance with exemplary embodiments.

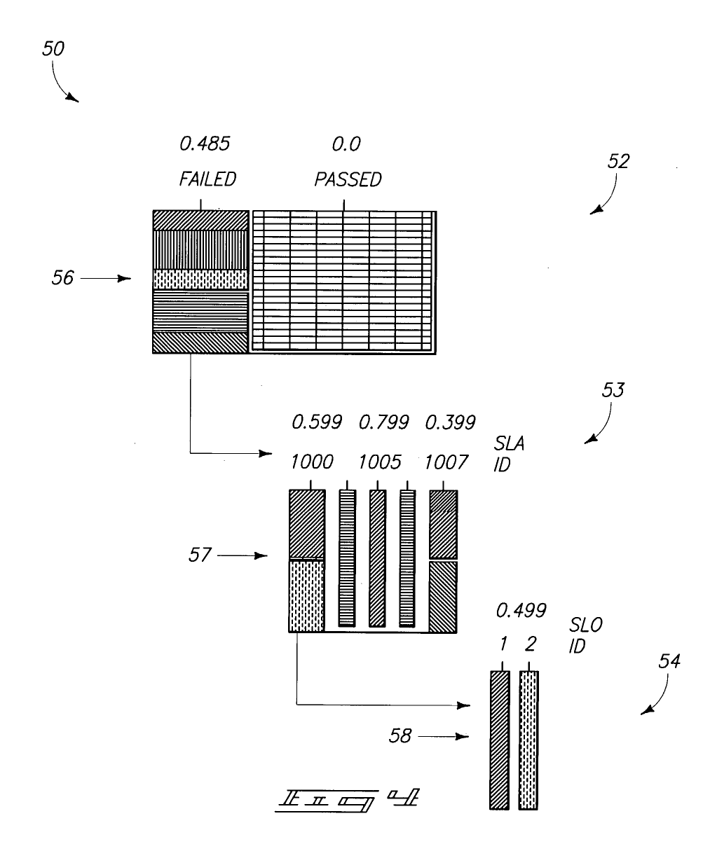

Referring to FIG. 3, a data image 30 corresponding to the depiction of data is illustrated according to one exemplary embodiment. The data image 30 comprises a pixel-based graph in the depicted embodiment wherein individual data items may correspond to individual pixels. Additional information regarding pixel-based graphs are described in a U.S. patent application titled “A Method for Visualizing Large Volumes of Multiple-Attribute Data Without Aggregation Using a Pixel Bar Chart,” filed Jul. 27, 2001, having Ser. No. 09/917,393, and the teachings of which are incorporated by reference herein.

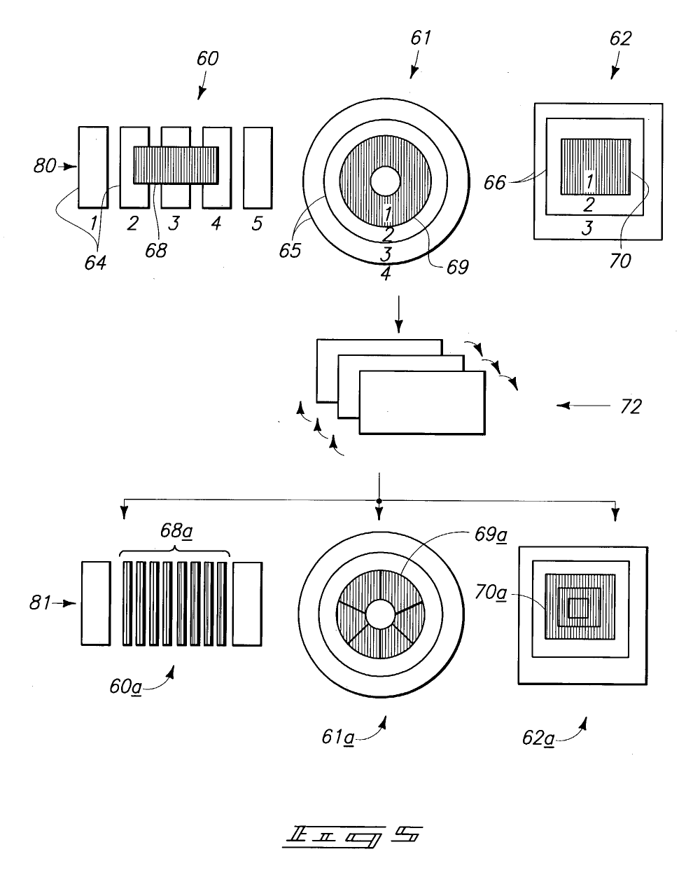

Data image 30 comprises a plurality of graphical representations 32-37 individually comprising bar charts and arranged according to a plurality of respective hierarchical levels 40-42 in the example of FIG. 3. The respective hierarchical levels 40-42 may indicate different levels of resolution for one or more attribute. In one embodiment, the different levels of resolution may be provided according to one or more common attribute (e.g., time) depicted relative to the X-axis. In the illustrated image 30, data items are arranged according to a time attribute having a first scale (e.g., days) in graphical representation 32, a second scale (e.g., hours) in graphical representations 33-34, and a third scale (e.g., 15 minute increments of an hour for four illustrated bars) in graphical representations 35-37. As shown, the resolution of the time attribute increases from days to minutes in the respective hierarchical levels 40-42 in the depicted example. A plurality of attributes may be associated with the X-axis of the respective graphical representations in other embodiments (e.g., FIG. 4).

The values of the X-axis define a plurality of respective groupings (e.g., bars) in the illustrated example. The size of individual groupings (e.g., width of individual bars) of the graphical representations 32-37 may be varied according to the number of data items for the respective groupings in one embodiment.

Other attributes of the data items may also be illustrated using data image 30. For example, the data items of FIG. 3 correspond to text messages comprising transactions with respect to a web site and having a plurality of additional attributes. For example, attributes of text messages may include day and time messages are received within a server of a web site, round-trip time corresponding to the amount of time from when the messages are received until processing by the web site is completed, number of messages stored in a database of the web site, number of incoming messages to the web site, and number of failed messages wherein processing by a server of the web site fails.

Visual indicators (e.g., axes) are used to distinguish different data items and/or different groups of data items. Other visual indicators apart from the axes may be used to provide information regarding attributes of individual data items. In the depicted example, visual indicators comprising different colors may be used to correspond to additional attributes of the data items. Other visual indications are possible, including monochrome shading, dots, lines, spacing, layout, color density (e.g., dark to light) or other distinguishable markings or indicia for respective attributes. Color information may correspond to different attributes in different representations 32-37. For example, color information is used to represent round-trip time in graphical representations 32, 33, 35, number of messages within the database of the server in graphical representation 34, number of incoming messages in graphical representation 36, and number of failed messages in graphical representation 37. Once the attribute to be represented by a given visual indicator is selected for a given graphical representation, the appropriate one of the available visual indicators (e.g., a specific one of a plurality of available colors) is associated with the value of the data item for the graphical representation by the processing circuitry 18 and corresponding to the value of the respective attribute for the selected data item.

Data items of the image 30 may be arranged so a user can rapidly analyze the data (e.g., for text message patterns) and use the analysis for corrective or additional actions (e.g., reconfigure a network configuration to correct unacceptable latency).

As mentioned previously, in graphical representations 32, 33, 35, data items are assigned one of a plurality of colors corresponding to the associated value of the data item for the respective attribute being depicted using color information. The color information of graphical representations 32, 33, 35 corresponds to respective lengths of time for the round-trip time attribute being depicted using visual indicators and wherein green represents data items with the shortest round-trip time and red represents data items with the longest round-trip time. Data items are depicted relative to the Y-axis of graphical representations 32, 33, 35 increasing from shortest round-trip times at the lower portion of the Y-axis to longest round-trip times at the upper portion of the Y-axis. Accordingly, the visual indicators may vary within a single grouping.

For graphical representation 34, data items are assigned one of the available visual indicators corresponding to the number of data items (e.g., messages) received ahead of the respective data item and waiting to be processed by a website server. Data items are depicted relative to the Y-axis of graphical representation 34 increasing from fewest number of waiting messages at the lower portion of the Y-axis to largest number of waiting messages at the upper portion of the Y-axis.

For graphical representation 36, data items are assigned one of the available visual indicators corresponding to the number of incoming messages associated with individual data items. In one embodiment, data items correspond to respective transactions with respect to placing an order via a website. For example, if a given transaction data item has an associated number of incoming messages above a threshold, then a first color can be used for the data item. A second color may represent the data item if the number of incoming messages is less than the threshold. Data items are depicted relative to the Y-axis of graphical representation 34 increasing from data items having a fewest number of incoming messages at the lower portion of the Y-axis to data items having an increased number of incoming messages at the upper portion of the Y-axis.

For graphical representation 37, data items are assigned one of the available visual indicators corresponding to the number of failed messages associated with the respective data items. A threshold may be provided and a first color associated with data items having a number of failed messages below the threshold and a second color associated with data items having a number above the threshold. Data items are depicted relative to the Y-axis of graphical representation 34 increasing from data items having a fewest number of failed messages at the lower portion of the Y-axis to data items having an increased number of failed messages at the upper portion of the Y-axis.

Accordingly, visual indicators may convey information regarding an attribute different than the attributes for which information is otherwise conveyed using the graphical representations (e.g., X-axis attribute). The information conveyed by visual indicators may vary from one graphical representation to another.

During exemplary operations, processing circuitry 18 provides the data items within graphical representation 32 according to the lowest resolution. Thereafter, a user may wish to further analyze a hierarchical hot area or subset 44 of data items responsive to the depiction of the graphical representation 32. A user may utilize the representation 32 depicted using user interface 12 to identify and select the subset 44. The user may also assign the attribute to be conveyed by visual indicators during the presentation of the selected data items in subsequent graphical representations. In one embodiment, the user may select data items from one or more grouping of data items (e.g., data items from one or more of the depicted bars in the exemplary pixel-based bar chart of data image 30).

Once selected, the processing circuitry 18 operates to access identifiers (e.g., x and y coordinates) of the data items of the subset 44, change the visual indicators (if appropriate) to arrange the identified data items according to the respective attributes, and to depict appropriate visual indicators in the next hierarchical level 41. The identification of the subset 44 of data items may result in partitioning of the selected data items into appropriate corresponding groupings and according to the scale of the graphical representations of the next hierarchical level. As illustrated, one or more graphical representation 33, 34 of the next hierarchical level 41 may result from the identified subset 44 and corresponding to the respective chosen visual indicator(s). Data image 30 may be referred to as a single attribute hierarchy if the visual indicator represents a common attribute for all graphical representations (e.g., representations 32, 33, 35) or a multiple-attribute hierarchy if the visual indicator represents a plurality of different attributes (e.g., representations 34, 36, 37).

Following depiction of the graphical representations 33, 34 of the next hierarchical level 41, the user may identify other respective desired subsets 46, 48, of data items to be further analyzed according to chosen attributes and visual indicators. The identification of subsets 46, 48, attributes and visual indicators results in arrangement of the identified data items into respective graphical representations 35-37 of hierarchical level 42.

As illustrated in the example of FIG. 3, the individual graphical representations 32-37 may be simultaneously represented within data image 30 upon display 14 or other imaging device. Indicia such as the depicted arrows and text may be utilized to indicate drill-down operations intermediate graphical representations of the different hierarchical levels 40-42 as well as identify attributes.

It is apparent that the graphical representations of a given hierarchical level including partitioned data items derived from graphical representations of another hierarchical level may convey information to user which is not conveyed in the graphical representations of the another hierarchical level. The newly conveyed information may comprise additional information regarding the same or different attributes (e.g., using the axes or visual indicators for the same attributes and/or different attributes) as the graphical representations of the another hierarchical level.

For example, relationships between the attributes of the data items may be derived from the graphical representations of the different hierarchical levels. For example, color visual indicators convey information regarding round-trip time in the graphical representation 32. In the example, green is short round-trip time, brown is medium length round-trip time and red in the longest round-trip time (e.g., transactions exceeding 30 second). As illustrated on the right side of graphical representation 32, days 11, 12, and 13 have the longest round-trip times (less green, more brown and red). In addition, days 11-13 include the largest number of text messages (widest respective bars) with the longest latency (most red coloring). Day 7 has the smallest width of the bars and has the least number of text messages across all of the days. The user may select or define the thresholds and visual indicators, or alternately, defaults may be used.

As previously mentioned, a user can further analyze the data by selecting subset 44 across a plurality of groupings (e.g., bars for days 11-13) and drilling down to the next time resolution. Hour 8 is illustrated in graphical representation 33 as the hour with the longest delay (most red). Accordingly, a user may further select subset 48 in hour 8 and drill down to the next time resolution (15-minute time intervals). In graphical representation 35, the first and the second groupings (0-14 and 15-30 min) have been found as the minutes with the longest delays (most red).

With respect to graphical representation 34, a user has re-distributed the selected data items of graphical representation 32 based on the number of waiting messages in the database. From graphical representation 32, the user may observe that hours 6-16 have an increased number of waiting messages stored in the database than at any other time of day and may be causing the relatively long latency in days 11-13.

Further, hour 8 has the most incoming messages (wider bar and more red). Hour 9 has the least incoming messages (narrow bar and less red). As illustrated by graphical representation 36, the user drilled down further to the 15-minute time interval hierarchical level 42 after selecting portions of hour groupings 8-16 to observe incoming message status.

In addition, the user may re-partition the data based on the number of failed messages as shown in graphical representation 37. The number of failed messages is distributed across all ranges of the time intervals of representation 37 wherein blue represents a small number of failed messages and red represents a large number of failed messages) and both colors may appear in all bar groupings to some extent.

By relating different bar groupings of the graphical representations of FIG. 3, the user may observe additional facts, patterns or trends including, for example, a long round trip time correlates to a relatively large number of waiting messages stored in the database, daytime hours (8-16) have more text messages than evening or morning hours, and failed messages occur across all round trip-times (e.g., blue appearing in all bar groupings of graphical representation 37.

As shown in FIG. 4, another exemplary data image 50 arranged as a pixel-based graph is shown. Data image 50 comprises a plurality of hierarchical levels 52-54 which include respective graphical representations 56-58. Data image 50 shows an exemplary data distribution of categorical business management data including different dividing or partitioning (e.g., X-axis) attributes including Service Level Agreement (SLA) status for graphical representation 56 (e.g., whether the agreement is timely completed by a contractor (passed) or not timely completed (failed)), identifiers of the contractors associated with failed SLAs for graphical representation 57, and identifiers of Service Level Objects (SLOS) of a given SLA identifier (e.g., SLA 1000 in the example) for graphical representation 58. Violation levels may be illustrated on the Y-axes to convey information regarding the timeliness of completion of the agreement wherein 0 is timely completed and 10 represents maximum violation or delay and minor violations are placed at the lower portions of the Y-axis and increasing to major violations at the upper portion of the Y-axis. The visual indicators convey information regarding violation status (e.g., passed or failed) and violation level wherein different visual indicators are used to represent different extents of the violations and also arranged by the Y-axis from violations of minimal extent at the lower portion of the representations and to violations of increased extent at the upper portion of the representations as mentioned above.

The hot area or subset of data items is selected by a user and corresponds to the left bar in graphical representation 56 in the depicted example. Graphical representation 57 provides additional information compared with information provided by representation 56 including the identification of respective SLAs (e.g., 1000-1007) in respective groupings and the corresponding extent of respective violations. Graphical representation 58 provides additional information compared with information provided by representation 57 with respect to identification of the SLOs such as SLOID1 in respective groupings for a given SLA (e.g., 1000 selected as the hot area or subset) and the corresponding extent of violations.

Referring to FIG. 5, exemplary drill-down or drill-up operations are described with respect to a plurality of types of pixel-based graphical representations including a bar graph 60, region graph 61 and spiral graph 62 in the depicted example. A user selects respective subsets 68-70 of data items following depiction of the respective graphical representations 60-62 (e.g., capture of a user's mouse clicks during selection operations and transform to coordinates for the subsets 68-70). Subsets 68-70 may include data items within an individual one of groupings 64-66 (i.e., comprising data items of part of or an entire grouping) or within a plurality of groupings 64-66 as shown in graphical representation 60.

The processing circuitry 18 may operate to transform the coordinates of display 14 to locations of the respective graphical representations 60-62. Processing circuitry 18 thereafter fills the subsets 68-70 with corresponding data of the selected data items. Respective link tables 72 may be generated and stored within memory 20 to correlate respective data items of graphical representations of different hierarchical levels 80-81 permitting drill-down and drill-up operations. Processing circuitry 18 may then redistribute data items in the next hierarchical level (e.g., level 81 in FIG. 5) including partitioning the selected data items with respective attributes into appropriate groupings.

Hierarchical level 81 depicts graphical representations 60a, 61a, 62a including exemplary expansion operations according to one embodiment wherein the partitioned data items of the subsets 68-70 are displayed along with the non-selected data items of the graphical representation 60-62 of the hierarchical level 80. Alternatively, the selected data items of the subsets 68-70 may be depicted independent of the non-selected data items as depicted in the examples of FIGS. 3-4.

Optimization may also be implemented to adjust the size of data items (e.g., pixels) to provide a user with a global view of the graphical representations 60-62 and 60a-62a of the different hierarchical levels 80-81. Optimization may be derived from the attributes of the data items (attributes may be weighted differently in different examples wherein more important items are displayed more prominently).

Aspects of at least one embodiment may be implemented using processor-usable or executable code stored within appropriate storage devices or communicated via a network or using other transmission media and configured to control appropriate processing circuitry. For example, processor-usable code may be provided by any appropriate method, apparatus or article of manufacture, such as an appropriate processor-usable medium as described above, or alternately embodied within a data signal (e.g., carrier wave, data packets, etc.) communicated via an appropriate medium, such as a communication network (e.g., the Internet and/or a private network) or other communication structure.

As described above, aspects of the invention enable information regarding selected data items to be arranged according to different attributes and/or different scales (e.g., resolutions). Information regarding large volumes of data items (e.g., tens or hundreds of thousands, millions or more) may be easily conveyed to an individual.

Exemplary aspects of the invention provide hot area dynamic selection for further partitioning a hot area or subset of data items of a pixel-based graphical representation to another level of hierarchy. Utilization of hot areas enables a user to dynamically select areas of data items anywhere in a graphical representation, to expand the selected area to depict information not illustrated in higher hierarchical levels, and/or to further partition the area without predefined drill-down structures. Users may reorganize data and further explore details of subsets of data items and to make appropriate strategies responsive to the analysis. The hot area may be constructed across multiple groupings or within a single grouping, perhaps to discover unknown data or unexpected results. Aspects of the invention enable partitioning or redistribution of data items of the hot area with the same or different attributes. One embodiment of the invention provides a global view to enable a user to view an entire data structure (e.g., graphical representations of the individual data images) simultaneously without having to change windows of a display.

The protection sought is not to be limited to the disclosed embodiments, which are given by way of example only, but instead is to be limited only by the scope of the appended claims.

What is claimed is:

1. An information visualization method comprising:
providing data, to a processor-based system, for a plurality of attributes of a plurality of data items;
first arranging the data items according to a common attribute having a first scale;
first displaying the data items arranged according to the first arranging;
selecting a subset of the data items responsive to the first displaying;
second arranging the data items of the subset according to the common attribute having a second scale of increased resolution compared with the first scale; and
second displaying the subset of the data items arranged according to the second arranging.

2. The method of claim 1 wherein the first arranging comprises associating at least one visual indicator with individual ones of the data items and configured to convey information regarding an other one of the attributes, and wherein the first displaying comprises displaying the at least one visual indicator regarding the other one of the attributes.

3. The method of claim 2 wherein the second arranging comprises associating at least one visual indicator with individual ones of the data items and configured to convey information regarding the other one of the attributes, and wherein the second displaying comprises displaying the at least one visual indicator regarding the other one of the attributes.

4. The method of claim 2 wherein the second arranging comprises associating at least one visual indicator with individual ones of the data items and configured to convey information regarding an additional one of the attributes, and wherein the second displaying comprises displaying the at least one visual indicator regarding the additional one of the attributes.

5. The method of claim 1 wherein the first displaying and the second displaying are simultaneous.

6. The method of claim 1 wherein the first displaying and the second displaying individually comprise displaying the data items in pixel-based graphs.

7. The method of claim 1 wherein the first displaying comprises displaying the data items in a plurality of respective groupings, and the selecting comprises selecting the data items from more than one of the groupings.

8. The method of claim 1 wherein the second displaying comprises expanding the selected data items arranged according to the first arranging.

9. An information visualization method comprising:
providing data, to a processor-based system, for a plurality of data items of a data set;
arranging the data items of the data set using the data;
first displaying the data items of the data set in a first graphical representation after the arranging;
identifying a subset of the data items after the displaying;
partitioning the data items of the subset responsive to the identifying; and
second displaying the partitioned data items in a second graphical representation to convey information regarding the partitioned data items in addition to information conveyed regarding the identified data items via the first graphical representation.

10. The method of claim 9 wherein the first graphical representation conveys information of an attribute of the data items of the data set and the second graphical representation conveys additional information regarding the attribute of the data items of the subset.

11. The method of claim 10 wherein the second graphical representation provides information having an increased resolution for the attribute.

12. The method of claim 9 wherein the first graphical representation conveys information of a first attribute of the data items of the data set and the second graphical representation conveys additional information regarding a second attribute of the data items of the subset.

13. The method of claim 9 wherein the first displaying and the second displaying individually comprise displaying the data items in pixel-based graphs.

14. The method of claim 9 wherein the first displaying and the second displaying comprise displaying visual indicators to convey information regarding at least one attribute of the respective data items.

15. An information visualization system comprising:
a display; and
processing circuitry configured to access data for a plurality of data items of a data set and to control the display to depict, using the accessed data, a first graphical representation comprising information of the data items, to access an identifier of a subset of the data items of the data set, and to control the display to depict a second graphical representation comprising information of the subset of the data items in addition to the information illustrated in the first graphical representation of the subset of the data items.

16. The system of claim 15 wherein the processing circuitry is configured to control the display to depict the first graphical representation to convey information of an attribute of the data items of the data set and to control the display to depict the second graphical representation to convey additional information regarding the attribute of the data items of the subset.

17. The system of claim 16 wherein the second graphical representation provides information having an increased resolution for the attribute.

18. The system of claim 15 wherein the processing circuitry is configured to control the display to depict the first graphical representation to convey information of a first attribute of the data items of the data set and to control the display to depict the second graphical representation to convey additional information regarding a second attribute of the data items of the subset.

19. The system of claim 15 wherein the processing circuitry is configured to control the display to depict the first and the second graphical representations comprising pixel-based graphs.

20. The system of claim 15 wherein the processing circuitry is configured to control the display to depict visual indicators of at least one attribute of the data items of the first and the second graphical representations.

21. An information visualization system comprising:
display means;
interface means for receiving user commands; and
processing means for accessing data for a plurality of data items of a data set, for controlling the display means to depict, using the accessed data, a first graphical representation of data items of the data set according to a first hierarchical level, for accessing an identifier of a subset of the data items received via the interface means responsive to the depiction of the first graphical representation, and for controlling the display means to depict, using the accessed data, a second graphical representation of the data items of the subset according to a second hierarchical level including information regarding the data items not identifiable in the first graphical representation.

22. The system of claim 21 wherein the first graphical presentation depicts information regarding an attribute of the data items and the second graphical presentation depicts information regarding the attribute of the data items of the subset and not identifiable in the first graphical representation.

23. The system of claim 22 wherein the processing means comprises means for controlling the display means to depict, using the accessed data, a third graphical representation of the data items of the subset and comprising information regarding an other attribute.

24. The system of claim 21 wherein the first graphical presentation depicts information regarding a first attribute of the data items and the second graphical presentation depicts information regarding a second attribute of the data items of the subset and different than the first attribute.

25. The system of claim 21 wherein the first graphical representation and the second graphical representation comprise pixel-based graphs.

26. An article of manufacture comprising:
processor-usable code configured to cause a processor to:
access data for a plurality of data items of a data set;
control a depiction of the data items according to a first hierarchical level;
select a plurality of data items; and
control a depiction of the selected data items according to a second hierarchical level to convey an increased amount of information for the selected data items compared with the first hierarchical level.

27. The article of claim 26 wherein the processor-usable code comprises code configured to cause a processor to access a user inputted command, and to select the data items responsive to the user inputted command.

28. The article of claim 26 wherein the processor-usable code comprises code configured to cause a processor to control the depiction of the first graphical representation to convey information of an attribute of the data items of the data set and to control the depiction of the second graphical representation to convey additional information regarding the attribute of the data items of the subset.

29. The article of claim 26 wherein the processor-usable code comprises code configured to cause a processor to control the depiction of the first graphical representation to convey information of a first attribute of the data items of the data set and to control the depiction of the second graphical representation to convey additional information regarding a second attribute of the data items of the subset and different than the first attribute.

30. The article of claim 26 wherein the processor-usable code comprises code configured to cause a processor to control the depiction of the first and the second graphical representations comprising pixel-based graphs.
